(19) United States
(12) Patent Application Publication
(10) Pub. No.: US 2006/0253250 A1
(43) Pub. Date: Nov. 9, 2006

(54) Satellite navigation device having real-time route-programming capability

(76) Inventor: Jien-Yang Chang, Taoyuan (TW)

Correspondence Address: RABIN & Berdo, PC, 1101 14TH STREET, NW, SUITE 500, WASHINGTON, DC, 20005, US

(21) Appl. No.: 11/402,956

(22) Filed: Apr. 13, 2006

(30) Foreign Application Priority Data
Apr. 15, 2005 (TW) 094112088

(51) Int. Cl. G01C 21/30

(52) U.S. Cl. 701/210

(57) ABSTRACT

A satellite navigation device having the real-time route-programming capability, comprising: a satellite positioning data receiver for receiving the satellite positioning signals and converting them into satellite positioning information; a traffic message receiver for receiving the traffic message signal; a microprocessor for digitizing the traffic message signal and converting it into traffic condition information; and a satellite navigation module for programming a mobile route based on the satellite positioning information and the traffic condition information, performing the navigation operation according to the programmed mobile route, and reprogramming in real-time the programmed mobile route according to the newly received traffic condition information.

### CROSS-REFERENCE TO RELATED APPLICATIONS

This non-provisional application claims priority under 35 U.S.C. § 119(a) on Patent Application No(s). 094112088 filed in Taiwan, R.O.C. on Apr. 15, 2005, the entire contents of which are hereby incorporated by reference.

### FIELD OF THE INVENTION

The invention relates to a satellite navigation device, and in particular, to a satellite navigation device having real-time route-programming capability.

### RELATED ART

With the rapid development of the information and communication industries, communication between people has become more convenient, for instance, through the utilization of the various portable/mobile communication devices. The development and deployment of the Global Satellite Positioning System (GPS) has further raised the quality and precision of communication. Presently, the satellite navigation device has gradually become a standard feature of transportation vehicles. Through the navigation system of the satellite navigation device, the driver of the vehicle has only to input the position of his destination, then the mobile route is programmed by the navigation system and is displayed by means of the electronic map in cooperation with the voice message, so as to facilitate the implementation and utilization of the satellite navigation system by the driver of the vehicle.

However, presently, route programming is done by making use of the map stored in the memory in advance. Thus, in this fixed type of route programming and guidance system, the mobile route cannot be adjusted dynamically according to traffic conditions. Therefore, the mobile route actually taken must be adjusted by the driver of the vehicle himself based on the existing traffic conditions of the mobile route obtained through the broadcast of the traffic information broadcasting system. However, to the driver unfamiliar with the geographic environment of the related route, this causes a lot of problems.

As such, the research and development of a satellite navigation device that can adjust in real-time the mobile route taken according to actual traffic conditions is the most urgent task in this field.

### SUMMARY OF THE INVENTION

In view of the above-mentioned problems and shortcomings of the prior art, the object of the invention is to provide a satellite navigation device having real-time route-programming capability, for providing a revised mobile route or suggesting a better mobile route by simultaneously receiving a satellite positioning information and a traffic condition information and analyzing them, thereby enhancing the quality and precision of the satellite navigation system.

Therefore, to achieve the above-mentioned objective, the invention provides a satellite navigation device having real-time route-programming capability, including: a satellite positioning data receiver, a traffic message receiver, a microprocessor, and a satellite navigation module. The details of each of these devices are described as follows.

The satellite positioning data receiver is used to receive the positioning signal of an apparatus, where the satellite navigation device is applied, via a satellite base station, and convert it into the satellite positioning information.

The traffic message receiver is used to receive the traffic message signal from a traffic message center. The traffic message receiver can include a Radio Data System (RDS) receiver and a Digital Audio Broadcast (DAB) receiver.

The microprocessor is connected to the traffic message receiver and is used to perform digitized processing of the traffic message signal so as to convert it into the traffic condition information.

The satellite navigation module is used to receive the satellite positioning information and the traffic condition information to obtain the satellite positioning information corresponding to the present position of the apparatus and the traffic condition information corresponding to the present traffic condition, and on the basis of these information, to program a mobile route and perform a navigation operation according to the programmed mobile route. Moreover, the satellite navigation module is used to real-time readjust the programmed mobile route based on the traffic condition information re-received. The satellite navigation module includes: a first communication connection interface, a second communication connection interface, a data storage medium, a central processor unit, a memory, and a route-programming unit. The details of each of these devices are described as follows.

The first communication connection interface is used to provide the satellite positioning data receiver and the satellite navigation module with the transmission interface for the data transmission channel, to transmit the satellite positioning information. The first communication connection interface may be of the Universal Asynchronous Receiver Transmitter (UART) specification or the Universal Serial Bus (USB) specification and the like.

The second communication connection interface is used to provide the microprocessor and the satellite navigation module with the transmission interface for the data transmission channel, to transmit the traffic condition information. The second communication connection interface may be of the Universal Asynchronous Receiver Transmitter (UART) specification or the Universal Serial Bus (USB) specification and the like.

The data storage medium is used to store the satellite positioning information and the traffic condition information.

The central processor unit is connected to the data storage medium, is the central core unit of the satellite navigation module, and is utilized to process the satellite positioning information and the traffic condition information.

The memory is connected to the central processor unit to store the data waited to be processed by the central processor unit. The memory can be of the synchronous dynamic random access memory (SDRAM) or the synchronous double data rate (DDR) dynamic random access memory (DRAM).

The route-programming unit is connected to the central processor unit and is of a computer application program, which is executed by the central processor unit to program the mobile route.

Through the application and utilization of the satellite navigation device having real-time route-programming capability, the optimized mobile route can be obtained on the basis of the programmed mobile route in coordination with the traffic condition information corresponding to the actual traffic conditions from the traffic message center. Therefore, the quality and the precision of the satellite navigation system are enhanced.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below, which is for illustration only and thus is not limitative of the invention, wherein:

FIG. 1 is a system block diagram of the satellite navigation device having real-time route-programming capability according to the embodiment of the invention; and

FIG. 2 is a schematic diagram of the integration of the satellite positioning information and the traffic condition information into the information of a new format.

### DETAILED DESCRIPTION OF THE INVENTION

The purpose, construction, features, and functions of the invention can be appreciated and understood more thoroughly through the following detailed description with reference to the attached drawings.

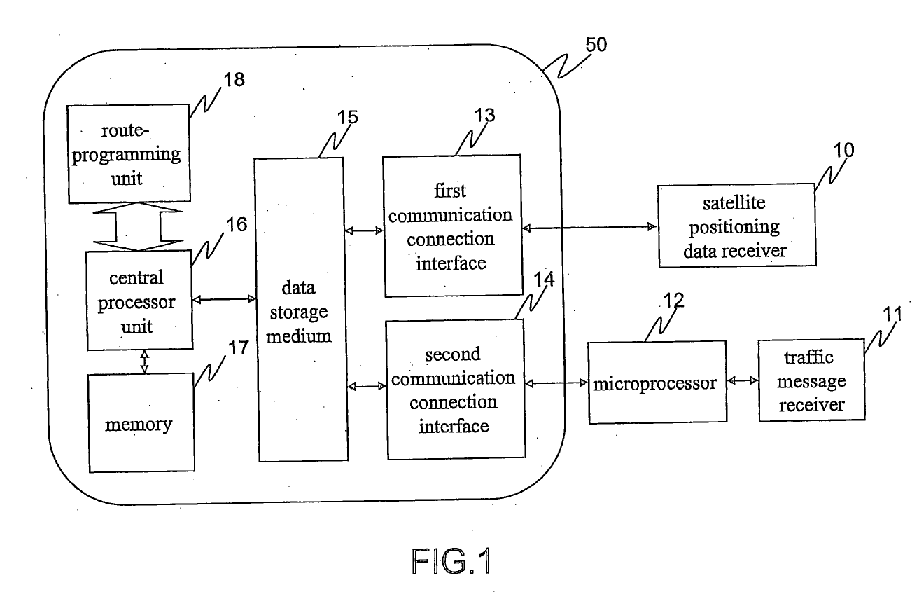

Refer to FIG. 1 for the system block diagram of the satellite navigation device having real-time route-programming capability according to the embodiment of the invention, including a satellite positioning data receiver 10, a traffic message receiver 11, a microprocessor 12, and a satellite navigation module 50.

The satellite positioning data receiver 10 is utilized to receive the satellite position signals from the satellites via the satellite base station. Such the position signals are received from at least 3 satellites to obtain the information corresponding to the present position of an apparatus, where the satellite navigation device is applied. The satellite positioning data receiver 10 can comprise an antenna (not shown) and a receiver circuit (not shown), wherein the receiver circuit is used to convert the satellite positioning signal into the satellite positioning information.

The traffic message receiver 11 is used to receive the traffic message signal transmitted from the Traffic Message Center (TMC). Herein, the traffic message receiver can comprise an antenna (not shown) and a receiver circuit (not shown). The traffic message receiver 11 can be of a Radio Data System (RDS) receiver or a Digital Audio Broadcast (DAB) receiver.

The microprocessor 12 is connected to the traffic message receiver 11 and is used to process the traffic message signal received by the traffic message receiver 11. It can perform a digitized processing of the signal, to convert the traffic message signal into traffic condition information.

The satellite navigation module 50 is used to process the information from the satellite positioning data receiver 10 and the traffic message receiver 11. That is, the satellite navigation module 50 can obtain the satellite positioning information corresponding to the present position of the apparatus and the traffic condition information corresponding to the present traffic condition. Subsequently, on the basis of the information, the satellite navigation module 50 can program a mobile route and perform the navigation operation according to the programmed mobile route. Moreover, the satellite navigation module 50 can readjust and reprogram the programmed mobile route upon receiving new traffic condition information. The mobile route means the shortest mobile route from the present position of the vehicle to its destination. The satellite navigation module 50 can include: a first communication connection interface 13, a second communication connection interface 14, a data storage medium 15, a central processor unit 16, a memory 17, and a route-programming unit 18. The details of each of these devices are described as follows.

The first communication connection interface 13 is connected to the satellite positioning data receiver 10 and is used to be the transmission interface for the data transmission channel, which has the capability of double direction data transmission. The first communication connection interface may be the communication connection port, which is of the Universal Asynchronous Receiver Transmitter (UART) specification or the Universal Serial Bus (USB) specification and the like.

The second communication connection interface 14 is connected to the microprocessor 12 and is used to provide the transmission interface for the data transmission channel, which has the capability of double direction data transmission. The second communication connection interface 14 may be the communication connection port, which is of the Universal Asynchronous Receiver Transmitter (UART) specification or the Universal Serial Bus (USB) specification and the like. Moreover, the traffic condition information is compatible with the data transmission format of the second communication connection interface 14.

Further, the microprocessor 12 is connected respectively to traffic message receiver 11 and the second communication connection interface 14, so that it can have fewer pins. Furthermore, it may only process the data (e.g. the traffic condition information) received from the traffic message receiver 11, so that a microprocessor with a simpler circuit construction and lower cost may be utilized.

The data storage medium 15 is connected respectively to the first communication connection interface 13 and the second communication connection interface 14, and is provided with the stored program of the Dynamic Link Library. In addition, it is provided with a storage area to store or temporarily store the satellite positioning information and the traffic condition information. The data storage medium 15 can be of the hard disk drive device or other hardware device having data storage capability.

The central processor unit 16 is connected to the data storage medium 15, is the central core unit of the satellite navigation module 50, and is utilized to process the signal transmission of the various units and the procedures in relation to instruction calling, execution and operation, including the calling and executing of the DLL program codes of the data storage medium 15, thus integrating the traffic condition information and the satellite positioning information into the same data format (for example, NMEA data format). The calling type of the DLL program can be classified into: Explicitly Import, Implicitly Import and Dynamically Import.

The memory 17 is connected to the central processor unit 16 to provide a storage area for storing temporarily the data waited to be processed by the central processor unit. The memory 17 can be of the synchronous dynamic random access memory (SDRAM) or the synchronous double data rate (DDR) dynamic random access memory (DRAM).

The route-programming unit 18 is of a computer application program, and is used to execute a programmed mobile route navigation operation through the central processor unit 16, and on the basis of these information, to program and generate the optimal mobile route depending on the actual traffic conditions by calculating the information corresponding to the actual traffic conditions from the traffic message receiver 11 through the central processor unit 16. In addition, the prompted information representing the existence of other mobile routes is displayed by the display device (not shown) for the user to adjust the mobile route.

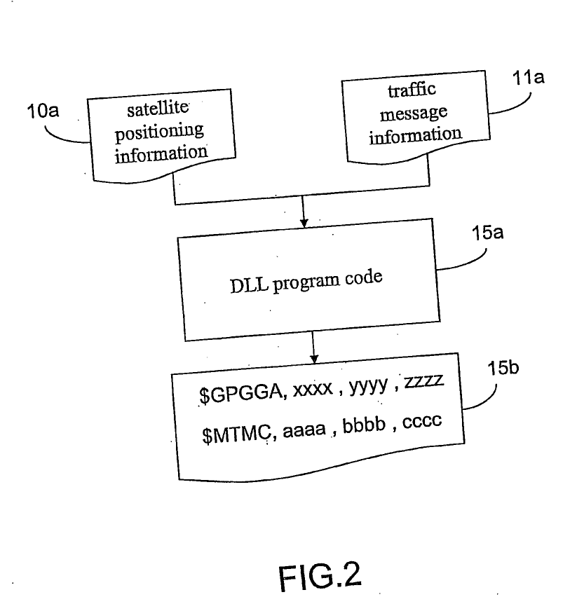

Next, refer to FIG. 2, which shows the schematic diagram of the integration of the satellite positioning information and the traffic condition information. Firstly, the satellite positioning information 10a and the traffic condition information 11a are obtained through the satellite positioning data receiver 10, the traffic message receiver 11, and the microprocessor 12. Then, they are converted into the National Marine Electronic Association (NMEA) message data format by making use of the DLL program 15a stored in the data storage medium 15, thereby providing the route-programming unit 18 with the operation parameters required to execute the real-time route-programming.

The data message in the NMEA format is transmitted in the form of sentences, e.g. the data format of ‘$GPGGA,xxxx,yyyy,zzzz” and ‘$MTMC,aaaa,bbbb,cccc” as shown in block 15b of FIG. 2. Each of the sentences is started with “$” with each field separated by “,”, and the length of the sentence is variable and can reach 82 characters at most. Each of the sentences can be divided into three sections: the header section, the data section and the ending section containing the checksum code.

The traffic condition information and the satellite positioning information are identified and distinguished through their header sections, and then the specific data in the data section of the traffic condition information is obtained and utilized as the parameter to perform the real-time route-programming operation. The traffic condition information is converted and integrated to the standard NMEA format, and further, is available for reading and processing by the route-programming unit 18 or other application programs.

Through the application and utilization of the satellite navigation device having the real-time route-programming capability, the optimized mobile route can be obtained on the basis of the programmed mobile route in coordination with the traffic condition information corresponding to the actual traffic condition from the traffic message center. Therefore, the quality and the precision of the satellite navigation system are enhanced.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A satellite navigation device having the real-time route-programming capability, comprising:
a satellite positioning data receiver for receiving a satellite positioning signal and converting the satellite positioning signal into a satellite positioning information;
a traffic message receiver for receiving a traffic message signal;
a microprocessor connected to the traffic message receiver for digitalizing and converting the traffic message signal into a traffic condition information; and
a satellite navigation module for programming a mobile route based on the received satellite positioning information and the received traffic condition information, performing a navigation operation according to the programmed mobile route, and real-time readjusting the programmed mobile route according to the re-received traffic condition information.

2. The satellite navigation device having the real-time route-programming capability as claimed in claim 1, wherein the satellite navigation module further comprising:
a first communication connection interface for being a transmission interface between the satellite positioning data receiver and the satellite navigation module to transmit the satellite positioning information;
a second communication connection interface for being a transmission interface between the microprocessor and the satellite navigation module to transmit the traffic condition information;
a data storage medium for storing the satellite positioning information and the traffic condition information;
a central processor unit connected to the data storage medium for processing the satellite positioning information and the traffic condition information;
a memory connected to the central processor unit for temporarily storing the data waited to be processed by the central processor unit; and
a route-programming unit connected to and executed by the central processor unit to program the programmed mobile route.

3. The satellite navigation device having the real-time route-programming capability as claimed in claim 2, wherein the data storage medium has a pre-stored computer program of a Dynamic Link Library for being called and executed by the central processor unit to transform the satellite positioning information in the same data format as the traffic condition information.

4. The satellite navigation device having the real-time route-programming capability as claimed in claim 3, wherein the data format is a National Marine Electronic Association (NMEA) data format.

5. The satellite navigation device having the real-time route-programming capability as claimed in claim 2, wherein the first communication connection interface is a Universal Asynchronous Receiver Transmitter (UART) connection port.

6. The satellite navigation device having the real-time route-programming capability as claimed in claim 2, wherein the first communication connection interface is a universal serial bus (USB) connection port.

7. The satellite navigation device having the real-time route-programming capability as claimed in claim 2, wherein the second communication connection interface is a Universal Asynchronous Receiver Transmitter (UART) connection port.

8. The satellite navigation device having the real-time route-programming capability as claimed in claim 2, wherein the second communication connection interface is a universal serial bus (USB) connection port.

9. The satellite navigation device having the real-time route-programming capability as claimed in claim 2, wherein the memory is a synchronous dynamic random access memory (SDRAM).

10. The satellite navigation device having the real-time route-programming capability as claimed in claim 2, wherein the memory is a synchronous double data rate (DDR) dynamic random access memory (DRAM).

11. The satellite navigation device having the real-time route-programming capability as claimed in claim 1, wherein the traffic message receiver is a Radio Data System (RDS) receiver.

12. The satellite navigation device having the real-time route-programming capability as claimed in claim 1, wherein the traffic message receiver is a Digital Audio Broadcast (DAB) receiver.
